(19) United States
(12) Patent Application Publication
(10) Pub. No.: US 2013/0105010 A1
(43) Pub. Date: May 2, 2013

(54) AUTOMATIC FIRE PUMP CONTROL SYSTEM AND METHOD

(71) Applicant: John E. McLoughlin, Hauppauge, NY (US)

(72) Inventor: John E. McLoughlin, Hauppauge, NY (US)

(73) Assignee: JNT Link, LLC, Nesconset, NY (US)

(21) Appl. No.: 13/644,149

(22) Filed: Oct. 3, 2012

Related U.S. Application Data
(60) Provisional application No. 61/552,981, filed on Oct. 28, 2011.

(51) Int. Cl. F17D 3/00

(52) U.S. Cl. 137/557

(57) ABSTRACT

An automatic control system includes a pressure sensor disposed in the supply line, a first valve disposed in the supply line operable to control incoming fluid flow, a pressure sensor disposed in the discharge line, a second valve disposed in the discharge line operable to control discharge fluid flow, and a nozzle coupled to a terminal end of a fire hose. The nozzle includes a valve, a pressure sensor, and a flow sensor, a third valve disposed in the nozzle operable to control fluid flow exiting the nozzle, and a user interface disposed on the nozzle operable to display information and receive user input. A controller is in communication with the valves, sensors, status indicator, and user interface, and operable to control the valves in response to the sensor measurements and user input, and provide an output provide an indication of operating status and sensor measurements.

### RELATED APPLICATION

This patent application claims the benefit of U.S. Provisional Patent Application No. 61/552,981 filed on Oct. 28, 2011.

### FIELD

The present disclosure relates to an automatic fire pump control system and method generally for firefighting applications.

### BACKGROUND

Firefighting is a highly dangerous occupation that subjects firefighters to many hazards. It is critically important that firefighters have the right amount of water flow (gallons per minute or gpm) when they are combating a fire in various conditions and environments. Determining the water flow rate in a fire hose is an important task for firefighters responsible for operating fire apparatus pumps. Delivering water at the proper flow rate and pressure to firefighters controlling the fire hose nozzles is vital to ensure safe operations. Pressures and flow rates too low will be insufficient for fire control, while pressures and flow rates that are too high creates dangerous conditions with handling the nozzle, burst hose, and other hazards.

### BRIEF DESCRIPTION OF THE DRAWINGS

FIG. 1 is a simplified block diagram of an exemplary embodiment of an automatic fire pump control system according to the present disclosure;

FIG. 2 is a simplified diagram of an exemplary embodiment of a fire hose nozzle according to the present disclosure; and

FIG. 3 is a simplified block diagram of an exemplary embodiment of the control system for the automatic fire pump control system according to the present disclosure.

### DETAILED DESCRIPTION

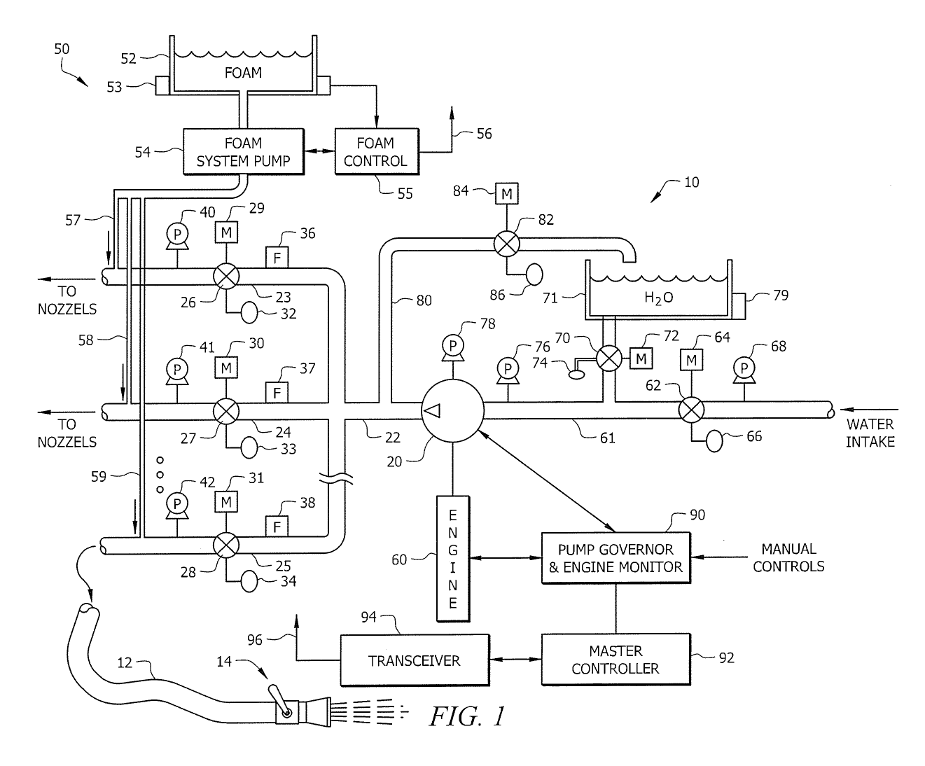

FIG. 1 is a simplified block diagram of an exemplary embodiment of an automatic fire pump control system 10 generally for firefighting applications. Referring to FIG. 1, one or more fire hoses 12 are used to deliver pressurized water, foam, chemicals, or another fluid to the site of a fire to be extinguished. The fire hose 12 is equipped with a fire hose nozzle 14 that is operable to controllably deliver the pressurized fluid. More detailed description on the fire hose nozzle 14 is set forth below. The fire hose 12 is connected to a main centrifugal pump 20 via a series of fluid-conducting lines and devices, such as mixing manifolds, control valves, check valves, and pump discharge lines 22. These lines and devices may not be shown explicitly in FIG. 1 for the sake of brevity and clarity. The pump discharge line 22 is coupled to one or more parallel fluid-conducting lines 23-25, the flow in the lines controlled by valves 26-28 that may be operated by motors 29-31 and/or manual controls 32-34. A flow sensor 36-38 is situated in each line to measure the flow rate of the fluid, and a pressure sensor or transducer 40-42 is also provided to measure the fluid pressure in the conduit. Wireless transmitters (not explicitly shown for the sake of brevity and clarity) in communication with the valves, motors, and sensors are operable to transmit and receive electrical signals for the purpose of monitor and control.

The system 10 may further include an additive injection system 50 operable to inject a fire extinguishing additive into the discharge lines. The additive may include, for example, a Class A foam concentrate suitable for fighting wildfires and structural fires, and a Class B foam concentrate for extinguishing flammable liquid fires. The additive injection system 50 includes one or more holding tanks 52 coupled to one or more pumps 54, a controller 55, and a communication antenna 56. The controller 56 is operable to instruct the pump 54 to measurably pump the additives from the holding tank 52 to a number of fluid conduits 57-59 coupled to the pump discharge lines 22. The level of the additives in the tanks 52 is measured by level sensors 53. The additive injection system 50 may further include other elements and devices such as mixing manifolds and valves omitted from FIG. 1 for the sake of brevity and clarity. Wireless transmitters (not explicitly shown for the sake of brevity and clarity) in communication with various elements of the additive injection system 50 are operable to transmit and receive electrical signals for the purpose of monitor and control.

The main centrifugal pump 20 is coupled to and driven by a gasoline or diesel engine 60, and is further coupled to a supply line 61 that is connected to a fluid source, such as a fire hydrant, tanker truck, lake, and the like. A control valve 62 is disposed in the supply line 61 to control the flow from the fluid source to the pump 20. The control valve 62 may be actuated by a motor 64 and/or manual control 66. A pressure sensor or transducer 68 is disposed in the supply line to measure the pressure of the incoming fluid. The supply line 61 of the main centrifugal pump 20 is further coupled to the outlet of a truck-mounted water tank 71 controlled by a one-way check valve 70, which may be operated by a motor 72 and/or a manual control 74. Pressure sensors 76 and 78 are disposed in the supply line 61 and in the pump 20 to measure the pressure level for control and monitoring purposes. A level sensor 79 is operable to measure or determine the level of the fluid in the tank 71. A conduit 80 is further coupled to the pump discharge line 22 and leads to the tank 71 for the purpose of replenishing the water therein. A control valve 82 operable by a motor 84 and/or manual control 86 is disposed in the conduit 80 to control the flow of fluid. Wireless transmitters (not explicitly shown for the sake of brevity and clarity) in communication with the motors and sensors are operable to transmit and receive electrical signals for the purpose of monitor and control.

The engine 60 is under the control of a pump governor and engine monitor system 90, which is further coupled to or in communication with a master controller 92. The master controller 92 is further coupled to a transceiver 94 (via radio frequency, microwave, infrared, etc. using a suitable communication protocol now known or later developed) and communication antenna 96. The master controller 92 is operable to receive flow, pressure, level, and other sensor inputs, and user commands in the form of manual control, verbal commands, or via a user interface (push buttons, touch panels, etc.), to determine the optimal and safe operating parameters and issue instructions to operate the pumps, valves, motors, and other system elements. The master controller 92 may compare the sensor measurements with one or more threshold levels and trigger one or more corrective action in response to the sensor measurement comparison to the threshold levels. For example, if the fluid pressure at the nozzle drops below a predetermined threshold, then the master controller 92 may instruct the valve in the nozzle to be opened more, and/or to increase the pump speed, etc. to achieve and maintain the desired fluid pressure.

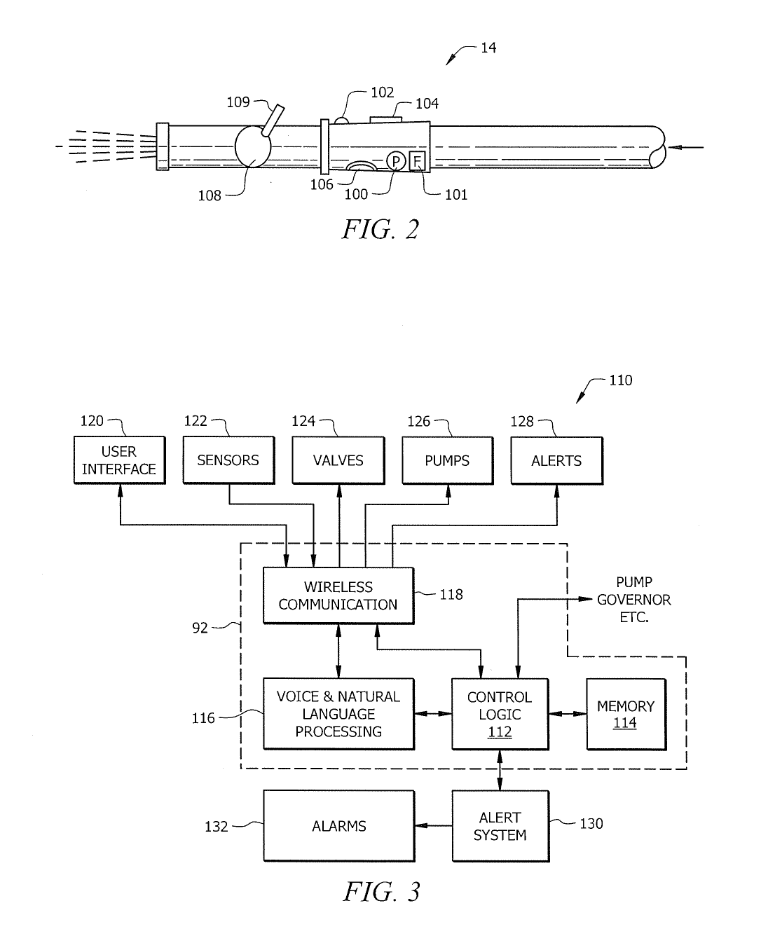

Referring to FIG. 2, the nozzle 14 additionally incorporates a pressure sensor 100 and a flow sensor 101 operable to measure the pressure and flow rate of the fluid in the nozzle. The nozzle also incorporates a status light 102 operable to signal the status of the fluid pressure in the fire hose 12. The status light indicator 102 may include one or more light source of suitable brightness or wattage such as LED (light-emitting diode) technology, or any other suitable technology. The status light indicator 102 may convey information in a color-coded manner. For example, emitting a green light to indicate optimal fluid pressure, a yellow light to indicate less than optimal fluid pressure, and a red light to indicate an alert condition. Alternatively, a flashing light at varying speeds may also be used to convey important information. The fire nozzle 14 further incorporates a user interface 104 that may incorporate a display panel, a touch panel, mechanically-actuated or soft virtual buttons, microphone and speaker 106, and other devices that are operable to provide textual, graphical, visual, and audible information to the user and/or receive tactile, data entry, verbal, and other forms of input from the user. The nozzle 14 further includes a control valve 108 and a manually-operable lever 109 adapted to open and shut the valve 108 to control the flow of fluids exiting the fire nozzle 14. The valve 108 may be a ball valve, multi-turn gate valve, or any other suitable valve used to control fluid flow.

The fire hose nozzle 14 may further incorporate a stream straightener, not shown explicitly, that helps to alleviate the problem of turbulent flow that may cause an erroneous pressure reading by the pressure transducer 100. The stream straightener may include a circular disk with a plurality of small openings defined therein disposed across the full opening of the nozzle 14. The flow straightener also aids in straightening the fluid stream exiting the nozzle 14.

FIG. 3 is a simplified block diagram of an exemplary embodiment of the control system 110 for the automatic fire pump control system 10 according to the present disclosure. The master controller 92 includes a number of logic modules each tasked with specific functions. The master controller 92 includes a control logic module 112 in communication with a memory 114 operable to store program instructions and data, a voice & natural language processing module 116 operable to perform voice recognition and process spoken commands, and also generate verbal or audible information to be played to the user. The master controller 92 further includes a wireless communication module 118 that enables wireless communication of data between the master controller 92 with the user interface 120, sensors 122, valves 124, pumps 126, and alert indicators 128. Although not shown explicitly, the user interface 120 may be disposed on the fire hose nozzle, in the fire truck dashboard, at other locations on the truck, and on the firefighters' helmet visor or mask in the form of heads-up-display, for example. The user interface 120 is operable to display textual and graphical information and alerts. The user interface 120 may additionally be operable to display soft virtual user input devices such as buttons and menus to receive input and commands from users. The audible information may be pre-recorded audio files played back at appropriate times and circumstances in response to current operating status (such as sensor inputs and alerts) and user input. Alternatively or in addition, voice synthesis technology may be used to generate the audible information and feedback. The helmet and/or mask worn by the firefighter may further incorporate the microphone and speaker components for communication of data with the firefighter. The control logic module 112 is further in communication with an alert system 130 that is operable to generate and transmit audible and visual alerts and alarms.

In operation, upon arrival at the fire scene, the pump operator typically engages the main centrifugal pump 20, secures the water supply, and adjusts the automatic electronic governor 90 to achieve the desired fluid discharge pressure at the fire hose nozzle. The pump operator may get the desired discharge pressure either by doing it manually using manual controls or with one preset button at the user interface on the nozzle that transmits control signals to the master controller 92. With the pump in operation, each nozzle person may take the hose line to their assigned location and each may open and close the valves on the nozzles as required. The nozzle persons may operate the valves remotely, either by a voice command and/or a push button via the user interface. When the nozzle person speaks, they may be required to identify themselves and/or identify which valve they are controlling. Alternatively, the transmitter and transmission logic associated with each valve may automatically generate and send an identification code in the transmitted signal (self-identify) to the master controller 92. The nozzle person may further issue commands via verbal commands or the user interface to request a specific type and percentage of a certain additive or foam in his/her line. The master controller 92 is operable to automatically process all user inputs and commands, sensor measurements, and system operating status, and to control the operations of the pump governor, the discharge valve, the foam system, and other elements in the system. The master controller 92 is operable to maintain a safe and optimal fluid pressure at the fire hose nozzles. Because the nozzle persons and pump operator have access to real-time operating status and information, they may take corrective action if the water flow or pressure is not adequate or not optimal.

If any fire hose nozzle requires more fluid pressure than is available with the nozzle valves fully open, the master controller 92 may instruct the pump governor to increase the pump RPM to increase the pressure slowly, such as in steps. The master controller 92 may also make adjustments on other components, such as control and check valves, to maintain previous flow rate. The master controller 92 may additionally keep all personnel informed as to the changes and adjustments that are being made and the current operating status. The user interface and/or audible information at each fire hose nozzle may further present information on flow and pressure at the nozzle, and level information on the foam and/or water tanks. If the water tank level is below a certain threshold, the master controller 92 may automatically open the valve 62 in the supply line 61 and valve 82 in the conduit 80 so that the external fluid source may be used to refill the water tank 71 and also supply the fire hoses. The master controller 92 may control the valves and pump governor to modulate the pressure of the incoming fluid so that proper pressure is maintained at the fire hose nozzles. When the tank is full or the discharge pressure drops significantly, the master controller 92 may shut off or adjust the control valve 82. If there is a loss in the external water supply, the master controller 92 may close the supply line valve 62 and open the valve 70 from the tank to the pump 20. The master controller 92 may further compute and inform (using display and/or audio information) the operators how long the water and chemical additives (foam) stored in the tanks would last at the current rate it is being used. If a serious issue arises, i.e., system failure, a mayday help, alarm, or alert in visual and audible forms will be issued to inform all personnel.

It should be noted that the word “water” is used herein to generally convey the concept of a fluid used for firefighting purposes, and “water” may include water, foam, chemicals, and other types of fire-suppression fluids.

Further notice should be given regarding the actual implementation of the system in that certain changes and modifications to the described system, though not described explicitly or in detail, are contemplated herein. For example, the master controller may be implemented using one or more CPU, or micro-controller circuits. Further, it is understood that a CPU is typically in operation with its attendant circuitry and software, such as memory, interfaces, drivers, etc. as known in the art. Additionally, the memory 114 may be implemented using one or more data storage devices of a variety of types now known or later developed. Similarly, the wireless communication may be achieved using any technology and protocol suitable for the firefighting application. Although wireless communication is the general way information may be conveyed, the communication between the master controller 92 and any controlled component and sensor may be achieved by wired and/or wireless means.

The features of the present invention which are believed to be novel are set forth below with particularity in the appended claims. However, modifications, variations, and changes to the exemplary embodiments described above will be apparent to those skilled in the art, and automatic fire pump control system and method described herein thus encompasses such modifications, variations, and changes and are not limited to the specific embodiments described herein.

What is claimed is:

1. An automatic control system operable to control a pump driven by an engine for firefighting applications, the pump being coupled to a supply line to receive incoming fluid and to a discharge line to dispense the fluid to a fire hose, the automatic control system comprising:
at least one pressure sensor disposed in the supply line operable to measure a supply line fluid pressure;
a first valve disposed in the supply line operable to control incoming fluid flow;
at least one pressure sensor disposed in the discharge line operable to measure a discharge line fluid pressure;
a second valve disposed in the discharge line operable to control discharge fluid flow;
a nozzle coupled to a terminal end of a fire hose, the nozzle includes a valve, a pressure sensor, and a flow sensor;
a third valve disposed in the nozzle operable to control fluid flow exiting the nozzle;
a user interface disposed on the nozzle operable to display information and receive user input; and
a controller in communication with the valves, pressure sensors, flow sensor, status indicator, and user interface, and operable to receive the measured fluid pressures and user input, control the valves in response to the fluid pressures and user input, and control the status indicator to provide an indication of operating status and fluid pressures.

2. The automatic control system of claim 1, wherein the user interface comprises a microphone operable to receive voice commands, and the controller being operable to process the voice commands, the sensor measurements, and control the valves in response to the voice commands.

3. The automatic control system of claim 1, wherein the user interface comprises a speaker operable to generate audible infolination in response to information provided by the controller.

4. The automatic control system of claim 1, further comprising a status indicator disposed on the nozzle operable to provide operating status information.

5. The automatic control system of claim 4, wherein the status indicator comprises a light indicator.

6. The automatic control system of claim 1, wherein the user interface comprises a display screen disposed on the nozzle.

7. The automatic control system of claim 1, wherein the user interface comprises a touch panel disposed on the nozzle.

8. The automatic control system of claim 1, wherein the user interface comprises a mechanically-actuatable button disposed on the nozzle.

9. The automatic control system of claim 1, further comprising a wireless communications system enabling wireless communications between the controller and at least one of the valves, pressure sensors, flow sensor, status indicator, and user interface.

10. The automatic control system of claim 1, wherein the valves are actuatable by at least one of manual control and motors remotely controllable by the controller.

11. The automatic control system of claim 1, wherein the valves are actuatable by both manual control and motors remotely controllable by the controller.

12. The automatic control system of claim 1, wherein the nozzle further comprises a flow straightener.

13. The automatic control system of claim 1, further comprising:
a level sensor operable to sense a fluid level in a storage tank;
the controller operable to receive the sensed fluid level and determine an amount of time at which the fluid in the storage tank would be exhausted at the current usage rate; and
the user interface operable to provide this time information to the user.

14. The automatic control system of claim 1, further comprising an additive system coupled to the discharge lines, the controller in communication with the additive system, and operable to inject additives in response to user input via the user interface.

15. The automatic control system of claim 1, wherein the user interface comprises:
a microphone operable to receive voice commands, and the controller being operable to process the voice commands, the sensor measurements, and control the valves in response to the voice commands; and
a speaker operable to generate audible information in response to information provided by the controller.

16. The automatic control system of claim 15, wherein the user interface is incorporated in a firefighter mask.

17. An automatic method to control a pump driven by an engine for firefighting applications, the pump being coupled to a supply line to receive incoming fluid and to a discharge line to dispense the fluid to a fire hose terminating in a nozzle, comprising:
receiving a pressure measurement of the fluid in the nozzle;
comparing the pressure measurement to a predetermined threshold;
providing a visual indication of the measured fluid pressure and operating status via a user interface disposed on the nozzle;
receiving a user input via a user interface disposed on the nozzle; and
issuing commands to result in a desired fluid pressure measurement in the nozzle.

18. The automatic method of claim 17, further comprising providing an audible indication of the measured fluid pressure and operating status via a speaker disposed on the nozzle.

19. The automatic method of claim 17, further comprising receiving voice commands via a microphone disposed on the nozzle, and processing the voice commands.

20. The automatic method of claim 17, further comprising receiving pressure measurements of fluids in the supply and discharge lines, and issuing commands to result in a desired fluid pressure measurement in the supply and discharge lines.

21. The automatic method of claim 17, wherein providing a visual indication comprises displaying information on a display panel disposed on the nozzle.

22. The automatic method of claim 17, wherein providing a visual indication comprises turning on a color-coded light indicator disposed on the nozzle.

23. The automatic method of claim 17, wherein providing a visual indication comprises flashing a light indicator disposed on the nozzle at a predetermined speed.

24. The automatic method of claim 17, further comprising injecting an additive into the discharge line in response to user input via the user interface.

25. The automatic method of claim 17, further comprising wirelessly communicating the pressure measurement, information to be displayed via the user interface, user input, and commands.

26. The automatic method of claim 17, further comprising providing an audible indication of the measured fluid pressure and operating status via a speaker disposed on a mask, and receiving voice commands via a microphone disposed on the mask and processing the voice commands.

27. The automatic method of claim 17, further comprising:
sensing a fluid level in a storage tank;
receiving the sensed fluid level and determining an amount of time at which the fluid in the storage tank would be exhausted at the current usage rate; and
provide this time information to the user.

28. An automatic control system operable to control a pump driven by an engine for firefighting applications, the pump being coupled to a supply line to receive incoming fluid and to a discharge line to dispense the fluid to a fire hose, the automatic control system comprising:
at least one pressure sensor disposed in the supply line operable to measure a supply line fluid pressure;
a first valve disposed in the supply line operable to control incoming fluid flow;
at least one pressure sensor disposed in the discharge line operable to measure a discharge line fluid pressure;
a second valve disposed in the discharge line operable to control discharge fluid flow;
a nozzle coupled to a terminal end of a fire hose, the nozzle includes a valve, a pressure sensor, and a flow sensor;
a third valve disposed in the nozzle operable to control fluid flow exiting the nozzle;
a user interface disposed on the nozzle operable to display information and receive user input, including a microphone operable to receive voice commands, and the controller being operable to process the voice commands, the sensor measurements, and control the valves in response to the voice commands, and a speaker operable to generate audible information in response to information provided by the controller; and
a controller in communication with the valves, pressure sensors, flow sensor, status indicator, and user interface, and operable to receive the measured fluid pressures and user input, control the valves in response to the fluid pressures and user input, and control the status indicator to provide an indication of operating status and fluid pressures.

29. The automatic control system of claim 28, further comprising an additive system coupled to the discharge lines, the controller in communication with the additive system, and operable to inject additives in response to user input via the user interface.
